(19) United States
(12) Patent Application Publication
(10) Pub. No.: US 2023/0317069 A1
(43) Pub. Date: Oct. 5, 2023

(54) CONTEXT AWARE SPEECH TRANSCRIPTION

(71) Applicant: INTERNATIONAL BUSINESS MACHINES CORPORATION, Armonk, NY (US)

(72) Inventors: HIROKI NAKANO, Otsu (JP); Yoshinori Kabeya, Kawasaki city (JP); SHO YONEZAWA, Kashiwa (JP); Yuma Nakamura, Tokyo (JP); Takanobu OHNUMA, Kawasaki (JP); TOMOYA SHINOHARA, Hamamatsu (JP)

(21) Appl. No.: 17/695,886

(22) Filed: Mar. 16, 2022

(51) Int. Cl. G10L 15/22; G10L 15/19

(52) U.S. Cl. CPC G10L 15/19; G10L 15/22; G10L 2015/025

(57) ABSTRACT

The present inventive concept provided for context aware speech transcription. The method includes obtaining speech corpora for a target domain. A corrected speech corpora is created by editing misused words in the speech corpora with correct words for the target domain. The training sets are prepared based on the speech corpora and corrected speech corpora, and an optimal percentage of the training sets to use for accurate transcription of speech related to the target domain is determined.

### BACKGROUND

Exemplary embodiments of the present inventive concept relate to speech transcription, and more particularly to context aware speech transcription.

The use of speech-to-text software to transcribe speech is becoming increasingly prevalent in various contexts (e.g., business, medicine, law, personal messaging, etc.). However, conventional voice-to-text software is unable to accurately differentiate between similar sounding phonetic words. This problem is exacerbated when considering users’ idiosyncratic pronunciations of a same spoken word and autocorrection. Thus, a transcribed word may be inaccurate for a given context. A standard spoken word conversion table is unavailing because it causes a uniform transcription of a spoken word based on the nearest phonetic similarity and neglects the context. Thus, inaccurate transcription of spoken words from speech may cost time and/or money for a user to manually review and correct. Moreover, a third-party reading the inaccurate transcription of spoken words may waste time attempting to decipher the inaccurate transcription’s true meaning, or worse, unknowingly adopt an erroneous transcription’s meaning.

### SUMMARY

Exemplary embodiments of the present inventive concept relate to a method, a computer program product, and a system for context aware speech transcription.

According to an exemplary embodiment of the present inventive concept, provided is a method for context aware speech transcription. The method includes obtaining speech corpora for a target domain. A corrected speech corpora is created by editing misused words in the speech corpora with correct words for the target domain. Training sets are prepared based on the speech corpora and corrected speech corpora, and an optimal percentage of the training sets to use for accurate transcription of speech related to the target domain is determined.

According to an exemplary embodiment of the present inventive concept, a computer program product for context aware speech transcription is provided. The computer program includes one or more computer-readable storage media and program instructions stored on the one or more computer-readable storage media. The program instructions include a method. The method includes obtaining speech corpora for a target domain. A corrected speech corpora is created by editing misused words in the speech corpora with correct words for the target domain. The training sets are prepared from the speech corpora and corrected speech corpora, and an optimal percentage of the training sets to use for accurate transcription of speech related to the target domain is determined.

According to an exemplary embodiment of the present inventive concept, a computer system is provided for context aware speech transcription. The system includes one or more computer processors, one or more computer-readable storage media, and program instructions stored on the one or more of the computer-readable storage media for execution by at least one of the one or more processors. The program instructions include a method. The method includes obtaining speech corpora for a target domain. Creating a corrected speech corpora by editing misused words in the speech corpora with correct words for the target domain. The training sets are prepared from the speech corpora and corrected speech corpora, and an optimal percentage of the training sets to use for accurate transcription of speech related to the target domain is determined.

### BRIEF DESCRIPTION OF THE DRAWINGS

The following detailed description, given by way of example and not intended to limit the exemplary embodiments solely thereto, will best be appreciated in conjunction with the accompanying drawings, in which:

FIG. 1 is a schematic diagram of a context aware speech transcription system 100, in accordance with an exemplary embodiment of the present inventive concept.

FIG. 2 is a flowchart of training and applying a context aware speech transcription model 200, in accordance with an exemplary embodiment of the present inventive concept.

FIG. 3 is an example of training a context aware speech transcription model 200 using a constraint approach, in accordance with an exemplary embodiment of the present inventive concept.

FIG. 4 illustrates a block diagram depicting hardware components used in the context aware speech transcription system 100 of FIG. 1, in accordance with an exemplary embodiment of the present inventive concept.

FIG. 5 illustrates a cloud computing environment in accordance with an exemplary embodiment of the present inventive concept.

FIG. 6 illustrates abstraction model layers in accordance with an exemplary embodiment of the present inventive concept.

It is to be understood that the included drawings are not necessarily drawn to scale/proportion. The included drawings are merely schematic examples to assist in understanding of the present inventive concept and are not intended to portray fixed parameters. In the drawings, like numbering may represent like elements.

### DETAILED DESCRIPTION OF THE DRAWINGS

Exemplary embodiments of the present inventive concept are disclosed hereafter. The disclosed exemplary embodiments are merely illustrative of the claimed system, method, and computer program product. The present inventive concept may be embodied in many different forms and should not be construed as limited to only the exemplary embodiments set forth herein. Rather, these included exemplary embodiments are provided for completeness of disclosure and to facilitate an understanding to those skilled in the art. In the detailed description, discussion of well-known features and techniques may be omitted to avoid unnecessarily obscuring the presented exemplary embodiments.

References in the specification to “one embodiment,” “an embodiment,” “an exemplary embodiment,” etc., indicate that the embodiment described may include a particular feature, structure, or characteristic, but not every embodiment may necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of the exemplary embodiments of the present inventive concept, in the following detailed description, some processing steps or operations that are known in the art may have been combined for presentation and for illustration purposes, and in some instances, may have not been described in detail. Additionally, some processing steps or operations that are known in the art may not be described at all. It shall be understood that the following detailed description is focused on the distinctive features or elements of the present inventive concept according to various exemplary embodiments.

As referenced above, the present inventive concept pertains to the context aware transcription of speech which facilitates accurate comprehension and transcription of speech for target domains

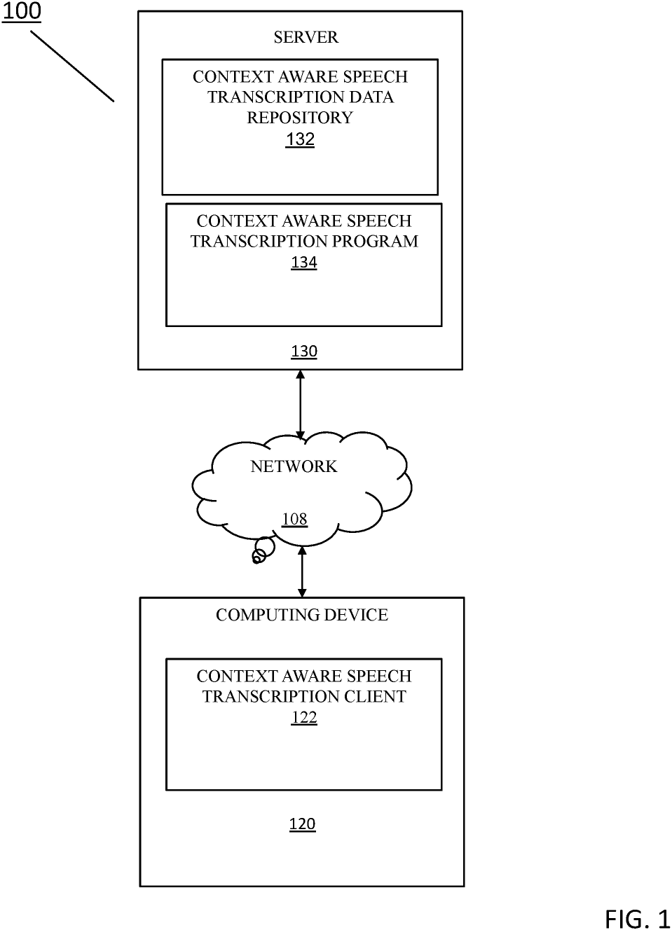

FIG. 1 is a schematic diagram of the context aware speech transcription system 100, in accordance with an exemplary embodiment of the present inventive concept.

The context aware speech transcription system 100 may include a network 108, a computing device 120, and a context aware speech transcription server 130, which may be interconnected via the network 108. Programming and data content may be stored and accessed remotely across one or more servers via the network 108. Alternatively, programming and data may be stored locally on one or more physical computing devices 120.

The network 108 may be a communication channel capable of transferring data between connected devices. The network 108 may be the Internet, representing a worldwide collection of networks 108 and gateways to support communications between devices connected to the Internet. Moreover, the network 108 may utilize various types of connections such as wired, wireless, fiber optic, etc., which may be implemented as an intranet network, a local area network (LAN), a wide area network (WAN), or a combination thereof. The network 108 may be a Bluetooth network, a Wi-Fi network, or a combination thereof. The network 108 may operate in frequencies including 2.4 GHz and 5 GHz internet, near-field communication, Z-Wave, Zigbee, etc. The network 108 may be a telecommunications network used to facilitate telephone calls between two or more parties comprising a landline network, a wireless network, a closed network, a satellite network, or a combination thereof. In general, the network 108 may represent any combination of connections and protocols that will support communications between connected devices.

The computing device 120 may include a context aware speech transcription client 122. The computing device 120 may be an enterprise server, a laptop computer, a camera, a microphone, a scanner, a notebook, a tablet computer, a netbook computer, a personal computer (PC), a desktop computer, a server, a personal digital assistant (PDA), a smart phone, a mobile phone, a virtual device, a thin client, an IoT device, or any other electronic device or computing system capable of sending and receiving data to and from other computing devices. Although the computing device 120 is shown as a single device, the computing device 120 may be comprised of a cluster or plurality of computing devices, in a modular manner, etc., working together or working independently.

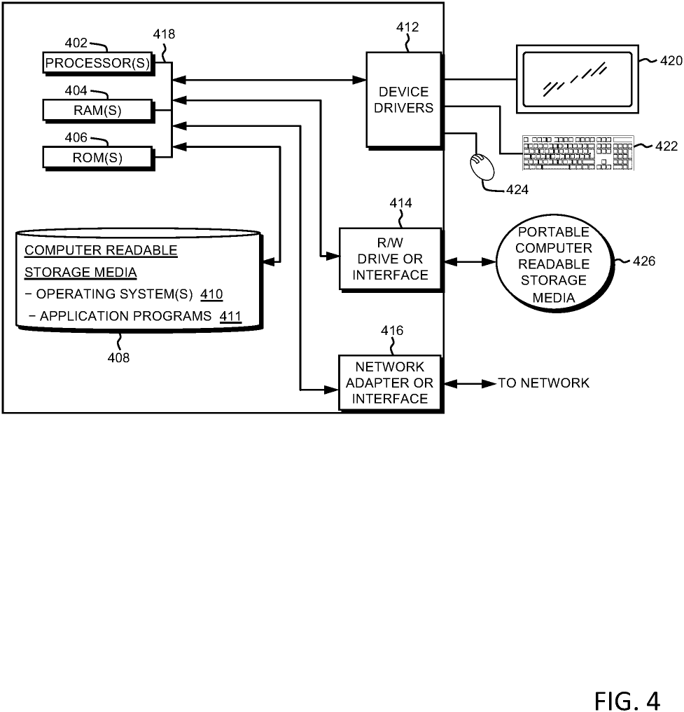

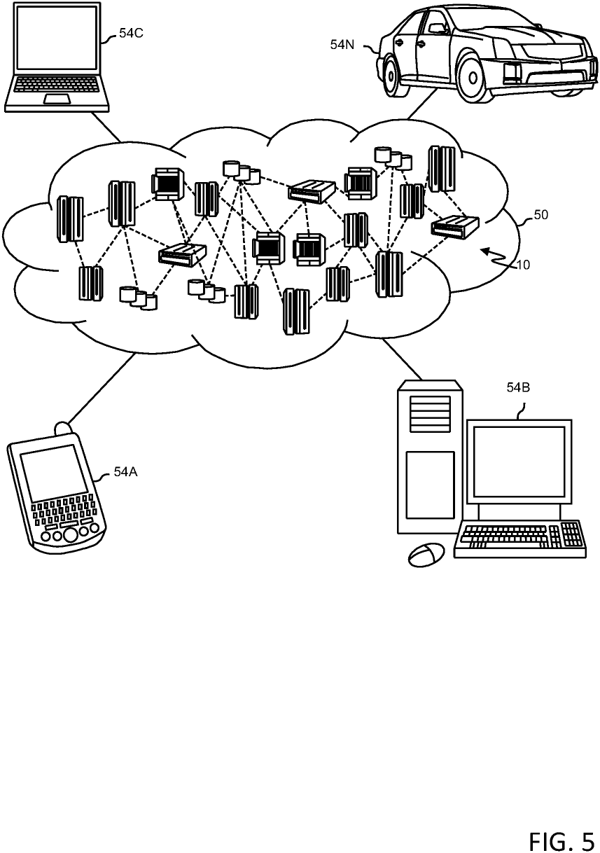

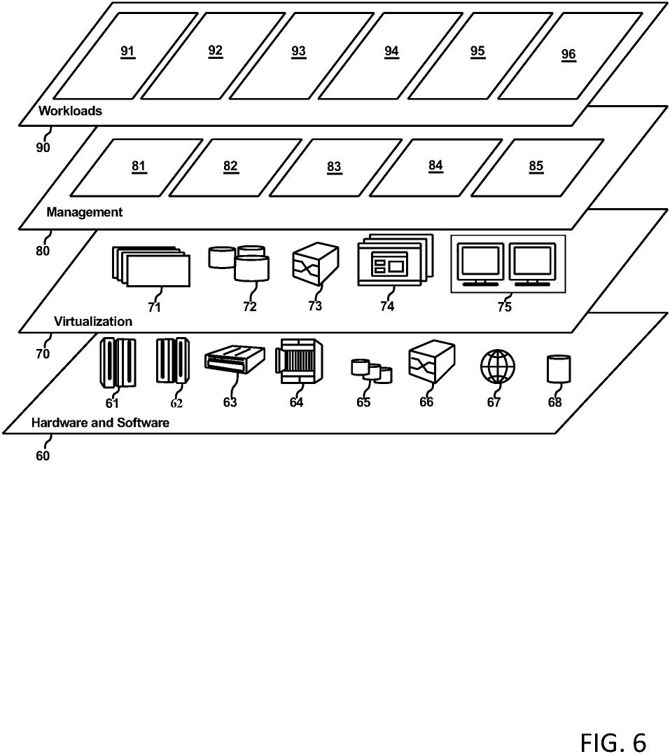

The computing device 120 is described in greater detail as a hardware implementation with reference to FIG. 4, as part of a cloud implementation with reference to FIG. 5, and/or as utilizing functional abstraction layers for processing with reference to FIG. 6.

The context aware speech transcription client 122 may act as a client in a client-server relationship with a server (for example, the context aware speech transcription server 130). The context aware speech transcription client 122 may exchange information (data) with the context aware speech transcription server 130 and/or other computing devices (e.g., computing devices 120) via the network 108. The context aware speech transcription client 122 may utilize various wired and wireless connection protocols for data transmission and exchange, including Bluetooth, 2.4 GHz and 5 GHz internet, near-field communication, etc.

The context aware speech transcription server 130 may include a context aware speech transcription data repository 132 and a context aware speech transcription program 134. The context aware speech transcription server 130 may act as a server in a client-server relationship with a client (e.g., the context aware speech transcription client 122). The context aware speech transcription server 130 may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, an IoT device, or any other electronic device or computing system capable of sending and receiving data to and from other computing devices.

Although the context aware speech transcription server 130 is shown as a single computing device, the present inventive concept is not limited thereto. For example, the context aware speech transcription server 130 may be comprised of a cluster or plurality of computing devices, in a modular manner, etc., working together or working independently.

The context aware speech transcription server 130 is described in greater detail as a hardware implementation with reference to FIG. 4, as part of a cloud implementation with reference to FIG. 5, and/or as utilizing functional abstraction layers for processing with reference to FIG. 6.

The context aware speech transcription data repository 132 may store context aware speech transcription models (for audio interpretation and text transcription correction), tables therefor, audio multimedia (e.g., speech), and textual multimedia (e.g., original speech corpora, user-corrected speech corpora, etc.).

The context aware speech transcription program 134 may be a software program configured to obtain speech corpora for a target domain (e.g., business, medicine, law, personal messaging, etc.), correct the speech corpora, train the context aware speech transcription model, and apply the context aware speech transcription model to new speech corpora.

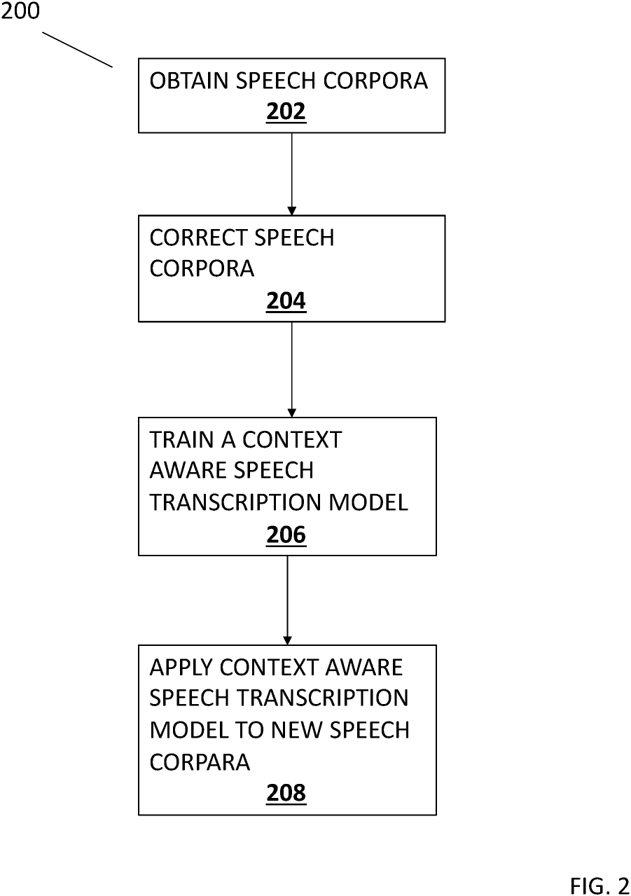

FIG. 2 is a flowchart of training and applying the context aware speech transcription model 200, in accordance with an exemplary embodiment of the present inventive concept.

Speech corpora may be obtained (step 202) by the context aware speech transcription program 134. Speech corpora may include transcribed speech. The speech corpora and/or portions thereof may be sorted into groups based on relevance to one or more target domains. If the target domain is not known from the outset, machine learning (e.g., named-entity recognition (NER), knowledge graph (KG), etc.) may be used in a cold-start process to infer the target domain(s) of the speech corpora from the inclusion and/or frequency of various predetermined keywords. The target domain of a speech corpora group may include at least one general category (e.g., business, medicine, law, personal messaging, etc.) and/or at least one more specific topic (e.g., dictated legal memos, patient histories, topics, text messages, etc.). The context aware speech transcription program 134 may obtain speech corpora by transcribing audio multimedia (e.g., speech) recorded in real-time (e.g., the user speaking) and/or pre-recorded (e.g., audio clips) into a digital speech corpus.

The context aware speech transcription program 134 may obtain the pre-recorded speech corpora and/or speech for transcription by performing an autonomous internet search (e.g., a user-initiated target domain keyword search) and/or by a user-initiated target domain keyword search of a data repository (e.g., the context aware speech transcription data repository 132) via the context aware speech transcription client 122. The autonomous search may include machine learning generated Boolean searches and/or natural language processing (NLP) assisted target domain keyword identification (e.g., NER) within speech corpora results. Alternatively, the user may manually upload speech corpora and/or speech for transcription to the context aware speech transcription program 134 (e.g., via the context aware speech transcription client 122). The obtained speech and/or the speech corpora may be crowd-sourced or obtained from an individual user. Regardless of the source, obtained speech may be transcribed into speech corpora.

For example, a doctor seeing a patient for a medical appointment may dictate a patient history to a computing device 120 running the context aware speech transcription client 122. The context aware speech transcription client 122 may upload and/or stream the dictated speech of the patient history to the context aware speech transcription program 134. The context aware speech transcription program 134 may transcribe the speech into a digital copy (speech corpus) made available to the doctor or an authorized third-party (e.g., with patient consent and/or patient identifiers removed) via the context aware speech transcription client 122.

The speech corpora for the target domain may be corrected (step 204). Errors (e.g., typos, misused words, improper grammar, improper syntax, etc.) in the speech corpora may be corrected digitally and/or physically (e.g., marking up a print) by the user. A marked-up print may be uploaded to the context aware speech transcription program 134 for analysis of hand-written edits (e.g., using optical character recognition (OCR)). Misused words for correction may include transcribed words that are unintended or otherwise inaccurate given the context (e.g., the target domain, semantic sentence/paragraph topic, etc.). A misused word may be attributable to a speech transcription error due to phonetic similarity to an intended correct word and/or an inadvertent speaker misuse (e.g., mispronunciation, word confusion, improper prefix/suffix, etc.).

A context aware speech transcription table may be generated by the context aware speech transcription program 134 for each correct word and a corresponding plurality of misused words. Each context aware speech transcription table may include a first column for correct words and a second column for the corresponding misused words (for example, see Table 1 below). Each row in the misused words column may represent a different misused word for a same correct word. The text within each row of the context aware speech transcription table may include a text segment (e.g., at least a partial sentence, paragraph, etc.) which includes the correct and/or misused word from the target domain speech corpora and surrounding words evidencing context (e.g., predetermined keywords).

In an embodiment, artificial intelligence (e.g., a transformer) may be used to flag potential typos in the digital copies of the speech corpora for user consideration/review in advance of correction. An uncommon cooccurrence of words (e.g., within a predetermined number of characters, sentences, paragraphs, etc.), inclusion of a commonly confused word, improper syntax (e.g., tense, element of speech, etc.), and/or transcribed words for which the context aware speech transcription program 134 had a low scored selection confidence from among competing similar words may be flagged for user review (e.g., highlights, annotations, brackets around an entire potential misused word or portions thereof).

Syntactic relationships between words in a text segment may be identified using NLP (e.g., using a parsing tree). In an embodiment, deep semantic parsing, also known as compositional semantic parsing, may be used to create elaborate parse trees of syntax relationships between adjacent words. Thus, the intended rather than literal construction of sentences with correct words may be better extrapolated. In an embodiment, semantic parsing and/or a knowledge graph (KG) may be used to flag potential misused words that are uncommon in the given context (e.g., target domain, more specific sentence/paragraph topic, etc.), particularly if a correct word is similar to a potential misused word and better fits the given context (e.g., the target domain). The KG may represent a network of keywords for a target domain-e.g., objects, events, situations, concepts, etc.—and illustrates the relationships between them. Semantic parsing and the KG may be used to help discern whether a word is misused based on the target domain.

For example, the context aware speech transcription program 134 may flag potential misused words for the doctor and/or the authorized third-party correcting the transcribed patient history to review in the sentence: “The patient presents with the [t]hief complaint of [chole]lithias and reports severe abdominal pain.” “[T]hief” is flagged for uncommon context and common misuse, and [chole]lithiasis is flagged as a common misused root word but with a generally proper context. Thief has no meaningful relation to the target domain of medicine based on application of a medical KG. The doctor and/or authorized third-party may correct the flagged word thief to the correct word “chief”. Cholecystitis. however, represents a pathological condition involving an inflamed gallbladder, whereas cholelithiasis may represent a benign, asymptomatic gallstone. Semantic parsing and/or a gastroenterological KG may be used for the similar words to search for respective symptoms and evaluate whether a potential correct word better fits the given context. From the KG, severe abdominal pain is more commonly associated with cholecystitis than cholelithiasis. Thus, the context aware speech transcription program 134 may propose the change, which is acknowledged by the doctor and/or authorized third-party.

The text with the corrected words thus recites: “The patient presents with the chief complaint of cholecystitis and severe abdominal pain.” The context aware speech transcription program 134 may then generate a table for the corrected words cholecystitis and chief complaint. The word chief complaint is susceptible to numerous other different misused words. For example:

TABLE 1

Speech Transcription Table

| | |
|---|---|
| SOURCE | TARGET |
| Beef plaint is headache | Chief complaint is headache |
| Visited the hospital with the thief complain of respiratory distress | Visited hospital with the chief complaint of respiratory distress |
| Medical examination with palpitation as the keefe constraint | Medical examination with palpitation as the chief complaint |
| Keefe restraint is tracheal stenosis | Chief complaint is tracheal stenosis |

The context aware speech transcription program 134 may train the context aware speech transcription model (step 206). The training of the context aware speech transcription model 200 may include the use of training sets to learn correct/misused words for the target domain (e.g., business, medicine, law, personal messaging, etc.). The training sets may include the original speech corpora and corrected speech corpora. In an embodiment, the training sets may include the context aware speech transcription tables. Each training set may include a text segment containing at least one misused word and the corresponding text segment containing the correct word for the target domain. In an embodiment, the context aware speech transcription model may use semantic parsing to distinguish between a misused word from the target domain from the same word used correctly in a non-target domain context (e.g., using semantic parsing), and thus avoid making an erroneous correction.

The context aware speech transcription model may be trained using a constraint approach. For example, the context aware speech transcription model may be trained by gradually reducing the training sets by percentage increments (e.g., 5%) over n times and applying the model to a different dataset for test to obtain a trend of correct answer rate. On the other hand, the context aware transcription model may also be trained by gradually increasing the training sets from 10% in percentage increments (e.g., 5%) over m times to obtain a trend of correct answer rate in the same manner. Words falling outside of the trained target domain at a given time interval are flagged (e.g., designated as unknown). The percentage of training sets used which have a peak correct answer rate across the two correct answer rate trends may be determined and used to train the context aware speech transcription model. In an embodiment, the misused word table entries and corrected speech may be correlated with corresponding speech fragments for speech model training. Machine learning may thus be used to train a context aware speech model such that speech is accurately transcribed in the first place.

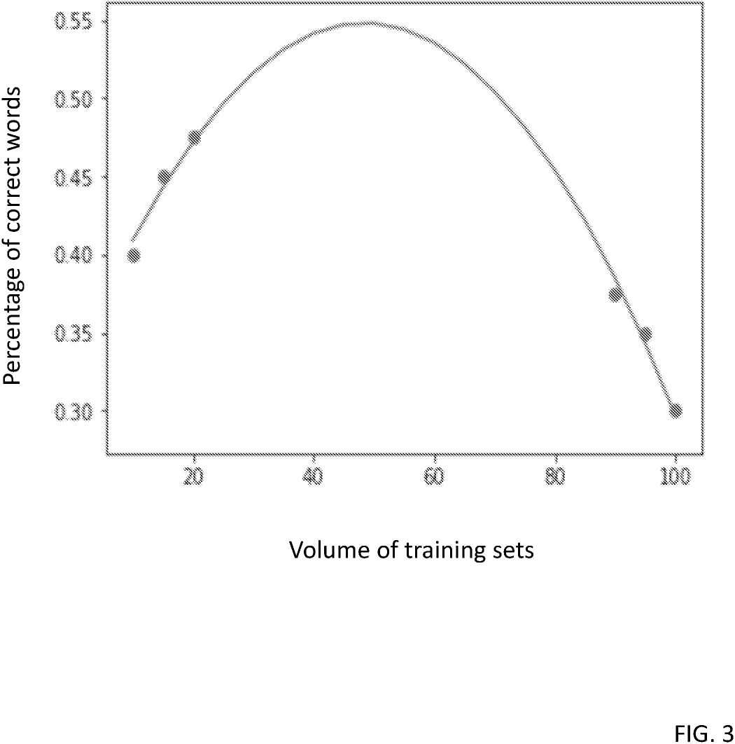

For example, with reference to FIG. 3, due to a constraint condition set by measuring 100% correct answer rate and 10% correct answer rate, an optimum value for the accurate transcription of a word, such as chief (despite similar misused words (e.g., thief, beef, keefe, etc.)), can be estimated properly for the target domain of medical care. The X-axis may represent the percentage of training sets for a target domain used, and the Y-axis may represent the correct answer rate.

The context aware speech transcription program 134 may apply the trained context aware speech transcription model to a new speech corpus (step 208). The context aware speech transcription program 134 may obtain the new speech corpus in a similar manner to the process described above with reference to step 202. The context aware speech transcription model may be configured to identify misused words in the new speech corpus and automatically correct them based upon the optimal training set misused word/correct word domain. Identified correct words from the optimal training set misused word/correct word domain may be output unchanged. Unknown words falling outside of the optimal training set misused word/correct word domain (e.g., non-target domain related words or target domain related words falling outside of the optimal training set domain) may be flagged accordingly. Thus, the context aware speech transcription model may not alter unknown words that are outside of the optimal training set correct/misused word domain.

In an embodiment, the context aware speech transcription program 134 may be configured to compare substantial similarities between text segments (e.g., at least partial sentences) containing unidentified and/or misused words in the new speech corpus and text segments (e.g., at least partial sentences) containing correct words from the speech corpora and/or context aware speech transcription tables. Thus, unidentified misused words (e.g., due to misspelling or extra-domain autocorrect) may be correlated with an intended correct word. Text segment similarities may be determined based upon predetermined thresholds of matching keywords, semantics, syntax, etc. In an embodiment, text segments may be given text embedding vectors using pretrained language models (BART, BERT). A bag of noun phrases and verb phrases may be extracted from the text segments using an abstract meaning representation (AMR) parser. Similarity between any pair of text segments may be calculated as the aggregated similarity of the text embedding vectors and the bags of noun-phrases of verb-phares (e.g., using S-Bert and cosine similarity between sentence embeddings to identify similar decisions/rules).

Thus, unknown words that differ in precise spelling and/or syntax (within a predetermined degree of error) may also be corrected and/or flagged for user review provided that the overall semantic meaning of a text segment parallels a text segment in the speech corpora and/or context aware speech transcription table.

For example, applying the context aware speech transcription model to a new speech corpus involving patient history, misused words “thief”, “beef plaint”, “keefe restrain” may be automatically corrected with the corresponding correct word, “chief”, given substantially similar text segments found in the target domain speech corpora and/or context aware speech transcription table. Correct words for the target domain of medicine, such as “chief complaint” may be unaltered by the context aware speech transcription model. Unidentified words falling outside of the optimal training set domain, such as “reef”, may be flagged (e.g., as <unknown>) and/or output as is. However, the sentences containing the unidentified terms “theif”, “bee fuh, and “keyf” may be analyzed for text fragment similarity to determine whether the unknown words represent a misspelled misused/correct word. The new text corpus which includes “chief complaint” in a different semantic context involving an unrelated target domain, such as politics, may be ignored. For the remaining unidentified words that have been flagged, the user may either correct them manually or ignore them.

FIG. 4 illustrates a block diagram depicting the context aware speech transcription system 100 of FIG. 1, in accordance with an exemplary embodiment of the present inventive concept.

It should be appreciated that FIG. 4 provides only an illustration of one implementation and does not imply any limitations regarding the environments in which different embodiments may be implemented. Many modifications to the depicted environment may be made.

Devices used herein may include one or more processors 402, one or more computer-readable RAMs 404, one or more computer-readable ROMs 306, one or more computer readable storage media 408, device drivers 412, read/write drive or interface 414, network adapter or interface 416, all interconnected over a communications fabric 418. Communications fabric 418 may be implemented with any architecture designed for passing data and/or control information between processors (such as microprocessors, communications and network processors, etc.), system memory, peripheral devices, and any other hardware components within a system.

One or more operating systems 410, and one or more application programs 411 are stored on one or more of the computer readable storage media 408 for execution by one or more of the processors 402 via one or more of the respective RAMs 404 (which typically include cache memory). In the illustrated embodiment, each of the computer readable storage media 408 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Devices used herein may also include a R/W drive or interface 414 to read from and write to one or more portable computer readable storage media 426. Application programs 411 on said devices may be stored on one or more of the portable computer readable storage media 426, read via the respective R/W drive or interface 414 and loaded into the respective computer readable storage media 408.

Devices used herein may also include a network adapter or interface 416, such as a TCP/IP adapter card or wireless communication adapter (such as a 4G wireless communication adapter using OFDMA technology). Application programs 411 on said computing devices may be downloaded to the computing device from an external computer or external storage device via a network (for example, the Internet, a local area network or other wide area network or wireless network) and network adapter or interface 416. From the network adapter or interface 416, the programs may be loaded onto computer readable storage media 408. The network may comprise copper wires, optical fibers, wireless transmission, routers, firewalls, switches, gateway computers and/or edge servers.

Devices used herein may also include a display screen 420, a keyboard or keypad 422, and a computer mouse or touchpad 424. Device drivers 412 interface to display screen 420 for imaging, to keyboard or keypad 422, to computer mouse or touchpad 424, and/or to display screen 420 for pressure sensing of alphanumeric character entry and user selections. The device drivers 412, R/W drive or interface 414 and network adapter or interface 416 may comprise hardware and software (stored on computer readable storage media 408 and/or ROM 406).

The programs described herein are identified based upon the application for which they are implemented in a specific one of the exemplary embodiments. However, it should be appreciated that any particular program nomenclature herein is used merely for convenience, and thus the exemplary embodiments should not be limited to use solely in any specific application identified and/or implied by such nomenclature.

It is to be understood that although this disclosure includes a detailed description on cloud computing, implementation of the teachings recited herein are not limited to a cloud computing environment. Rather, the exemplary embodiments of the present inventive concept are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

FIG. 5 illustrates a cloud computing environment, in accordance with an exemplary embodiment of the present inventive concept.

As shown, cloud computing environment 50 may include one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 40 and cloud computing environment 50 can communicate with any type of computerized device over any type of network and/or network addressable connection (e.g., using a web browser).

FIG. 6 illustrates abstraction model layers, in accordance with an exemplary embodiment of the present inventive concept.

Referring now to FIG. 6, a set of functional abstraction layers provided by cloud computing environment 50 (FIG. 5) is shown. It should be understood in advance that the components, layers, and functions shown in FIG. 6 are intended to be illustrative only and the exemplary embodiments are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfilment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and context aware speech transcription processing 96.

The exemplary embodiments of the present inventive concept may be a system, a method, and/or a computer program product at any possible technical detail level of integration. The computer program product may include a computer readable storage medium (or media) having computer readable program instructions thereon for causing a processor to carry out aspects of the present inventive concept.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present inventive concept may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present inventive concept.

Aspects of the present inventive concept are described herein with reference to flowchart illustrations and/or block diagrams of methods, apparatus (systems), and computer program products according to exemplary embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present inventive concept. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Based on the foregoing, a computer system, method, and computer program product for context aware speech transcription have been disclosed. However, numerous modifications, additions, and substitutions can be made without deviating from the scope of the exemplary embodiments of the present inventive concept. Therefore, the exemplary embodiments of the present inventive concept have been disclosed by way of example and not by limitation.

1. A method for context aware speech transcription, the method comprising:
obtaining speech corpora for a target domain;
creating a corrected speech corpora by editing misused words in the speech corpora with correct words for the target domain;
preparing training sets based on the speech corpora and the corrected speech corpora; and
determining an optimal percentage of the training sets to use for accurate transcription of speech related to the target domain.

2. The method of claim 1, further comprising:
training a context aware speech transcription model using the optimal percentage of training sets, wherein the training is performed in a constraint-based manner.

3. The method of claim 2, wherein the optimal percentage of training set domain contains fewer misused words than the target domain.

4. The method claim 3, wherein the prepared training sets include a context aware speech transcription table.

5. The method of claim 4, wherein the context aware speech transcription table contains text segments that include each correct word in the target domain and text segments including the corresponding misused words.

6. The method of claim 5, wherein each correct word corresponds to a plurality of different misused words.

7. The method of claim 1, wherein a knowledge graph (KG) is used to determine which text corpora belong to the target domain.

8. The method of claim 5, wherein the context aware speech transcription model automatically edits misused words with correct words in a new speech corpus.

9. The method of claim 8, wherein words in the new speech corpus which are outside of the optimal percentage of training set domain are flagged as unknown words.

10. The method of claim 9, wherein text segments including the unknown words are compared with substantially similar text segments from the optimal percentage of training set domain.

11. The method of claim 10, wherein the unknown words that are substantially similar to text segments from the optimal percentage of training set domain are corrected accordingly.

12. A computer program product for context aware speech transcription, the computer program comprising:
one or more computer-readable storage media and program instructions stored on the one or more computer-readable storage media, the program instructions including a method, the method comprising:
obtaining speech corpora for a target domain;
creating a corrected speech corpora by editing misused words in the speech corpora with correct words for the target domain;
preparing training sets based on the original speech corpora and the corrected speech corpora; and
determining an optimal percentage of the training sets to use for accurate transcription of speech related to the target domain.

13. The method of claim 12, further comprising:
training a context aware speech transcription model using the optimal percentage of training sets, wherein the training is performed in a constraint-based manner.

14. The method of claim 13, wherein the optimal percentage of training set domain contains fewer misused words than the target domain.

15. The method claim 14, wherein the prepared training sets include a context aware speech transcription table.

16. The method of claim 15, wherein the context aware speech transcription table contains text segments that include each correct word in the target domain and text segments including the corresponding misused words.

17. A computer system for context aware speech transcription, the system comprising:
one or more computer processors, one or more computer-readable storage media, and program instructions stored on the one or more of the computer-readable storage media for execution by at least one of the one or more processors, the program instructions including a method comprising:
obtaining speech corpora for a target domain;
created a corrected speech corpora by editing misused words in the speech corpora with correct words for the target domain;
preparing training sets based on the speech corpora and the corrected speech corpora; and
determining an optimal percentage of the training sets to use for accurate transcription of speech related to the target domain.

18. The method of claim 17, further comprising:
training a context aware speech transcription model using the optimal percentage of training sets, wherein the training is performed in a constraint-based manner.

19. The method of claim 18, wherein the optimal percentage of training set domain contains fewer misused words than the target domain.

20. The method claim 19, wherein the prepared training sets include a context aware speech transcription table.
